(19) United States
(12) Patent Application Publication
(10) Pub. No.: US 2026/0085609 A1
(43) Pub. Date: Mar. 26, 2026

(54) ELECTRONICS-FREE FLOW SENSOR DOWNHOLE IN A WELLBORE

(71) Applicant: Halliburton Energy Services, Inc., Houston, TX (US)

(72) Inventors: Michael Linley Fripp, Singapore (SG); Joachim Alexander Pihl, Sandefjord (NO)

(21) Appl. No.: 18/895,821

(22) Filed: Sep. 25, 2024

(51) Int. Cl. E21B 47/113; E21B 47/12; E21B 49/08; G01F 1/56

(52) U.S. Cl. CPC E21B 47/113; E21B 47/12; E21B 49/08; G01F 1/56

(57) ABSTRACT

Techniques described herein involve an electronics-free downhole flow sensor. For example, a system can include a receiver positioned at a surface of a wellbore. A flow sensor can be positioned downhole in the wellbore. The flow sensor can include a wire positioned within a flow path of downhole fluid in the wellbore. The wire can oscillate based on flow of the downhole fluid. The flow sensor can also include a variable reluctance sensor that can detect an electrical signal that is generated by oscillation of the wire. The variable reluctance sensor can transmit the electrical signal to the receiver. The receiver may determine a resonant frequency based on the electrical signal and may determine a fluid velocity of the downhole fluid based on the resonant frequency.

### TECHNICAL FIELD

The present disclosure relates generally to wellbore operations and, more particularly (although not necessarily exclusively), to an electronics-free flow sensor positioned downhole in a wellbore.

### BACKGROUND

A wellbore can be formed in a subterranean formation for extracting produced hydrocarbon material and other suitable material. Various wellbore operations can be performed with respect to the wellbore. For instance, the wellbore operations can include drilling (e.g., forming the wellbore), stimulation (e.g., hydraulic fracturing or other similar stimulation operations), production operations, and other suitable wellbore operations. Devices may be deployed within the wellbore on a casing string for collecting and transmitting data related to the environment within the wellbore. The casing string, including the devices thereon, may be intended to remain within the wellbore for the life of the wellbore. A device positioned downhole may be exposed to an extreme environment, including heat and pressure. The design of such devices can be challenging, such as to ensure reliability of electronics and resist harm, such as broken, degraded, or damaged equipment due to the extreme environment. Even a device that survives the extreme environment downhole can eventually become outdated as technology advances, especially given that the life of the well may continue for five, ten, fifteen, twenty, or even thirty-plus years.

### BRIEF DESCRIPTION OF THE DRAWINGS

FIG. 1 is a schematic of a wellsite that includes an electronics-free downhole flow sensor according to one example of the present disclosure.

FIG. 2 is a diagram of a flow velocity sensor of an electronics-free downhole flow sensor according to one example of the present disclosure.

FIG. 3 is a cross-sectional diagram of a flow composition sensor in the electronics-free downhole flow sensor according to one example of the present disclosure.

FIG. 4 is a block diagram of a receiver for the electronics-free downhole flow sensor according to one example of the present disclosure.

FIG. 5 is a flow chart of a process for operating an electronics-free downhole flow sensor including a flow velocity sensor according to one example of the present disclosure.

FIG. 6 is a flow chart of a process for operating an electronics-free downhole flow sensor including a flow composition sensor according to one example of the present disclosure.

### DETAILED DESCRIPTION

Certain aspects and examples of the present disclosure relate to an electronics-free downhole flow sensor. The downhole flow sensor can measure flow rate and, in some examples, can measure fluid composition. For example, the flow sensor can include a wire that is exposed to downhole fluid in a wellbore. The downhole fluid flowing past the wire can cause the wire to vibrate. The vibration of the wire may change a magnetic field of the flow sensor, thus creating an electrical signal (e.g., a voltage). The flow sensor can also include a variable reluctance sensor that can detect the electrical signal that is generated by the vibration of the wire. This electrical signal may be transmitted uphole (e.g., via a cable, such as a tubing encased conductor (TEC) line) to a receiver. The receiver may use the electrical signal to determine a flow rate of the downhole fluid.

Measuring fluid flow in downhole environments may be important, particularly in multi-zone production environments. For example, different sections of a well may produce fluids at different rates or different compositions (e.g., different fractions of water and hydrocarbons). Determining flow rates or produced fluid composition from different production zones can provide valuable information about reservoir characteristics and can improve reservoir management by a large margin. It may be difficult, dangerous, or even impossible to replace flow sensors in wellbores due to relatively high temperatures downhole. And, a lifetime of a wellbore may be significantly longer than a lifetime of flow sensors with electronic components placed downhole due to the high temperatures. In contrast, the flow sensor described herein may be electronics-free and fiber optics-free. The flow sensor may therefore be unaffected by relatively high downhole temperatures due to only using passive components, such as a vibrating wire. Thus, using the electronics-free flow sensor described herein downhole may allow the flow rate and flow composition of downhole fluid to be detected indefinitely without requiring replacement.

In some examples, the electronics-free flow sensor may optionally include a resonant circuit that can be used to measure composition of downhole fluids. The resonant circuit may include an inductor and a capacitor that can be in contact with downhole fluid. Electrical pulses can be transmitted to the resonant circuit from uphole (e.g., via a TEC line). In some examples, the TEC line connected to the resonant circuit may be the same TEC line that is connected to the variable reluctance sensor detecting oscillation of the vibrating wire. The electrical pulse transmitted from uphole can excite the resonant circuit, which can resonate at a frequency that corresponds to the downhole fluid composition. The resonant frequency of the resonant circuit can be transmitted uphole (e.g., via the TEC line) to determine the fluid composition. Thus, having determined the fluid composition and the flow rate of the downhole fluid, a mass flow rate of the downhole fluid can be determined.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

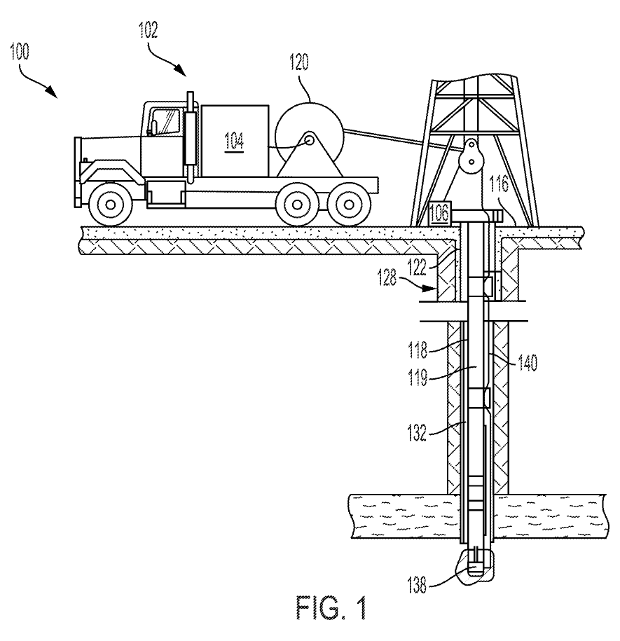

FIG. 1 is a schematic of a wellsite 100 that includes an electronics-free downhole flow sensor 138 according to one example of the present disclosure. Although a land-based production tubing system is depicted in FIG. 1, a production tubing string can be deployed from floating rigs, jackups, platforms, subsea wellheads or any other well location. Aspects of the disclosure may be used for producing hydrocarbons from a wellbore 122, performing fracturing operations, completion operations, or any other suitable wellbore operations.

The wellsite 100 can include production tubing system 102, which can utilize a production tubing string 118, e.g., to conduct various deployment, drilling, and production operations. As used herein, the term “production tubing string” can include any pipe string that may be deployed in a wellbore 122 including continuous or jointed metal tubulars such as low-alloy carbon-steel tubulars, composite tubulars, capillary tubulars, and the like. Additionally, although a production tubing system 102 with production tubing string 118 is depicted, the wellsite 100 can include any type of tubing. For example, completion tubing may be used in place of the production tubing string 118.

The production tubing string 118 can include an inner annulus or flow bore 119 extending along a length of the production tubing string 118. The production tubing system 102 may also include a power source 104 and a receiver 106 that can receive signals from downhole. The production tubing system 102 may be used in some examples for servicing a pipe system 128. For purposes of this disclosure, the pipe system 128 may include casing, risers, tubing, drill strings, completion or production strings, subs, heads, or any other pipes, tubes, or equipment that couples or attaches to the foregoing, such as collars, cleaning tools, and joints, as well as the wellbore 122 itself and laterals in which the pipes, casing, and strings may be deployed. In this regard, the pipe system 128 may include one or more casing strings, which may be cemented in wellbore 122. An annulus 132 is formed between the walls of sets of adjacent tubular components, such as concentric casing strings or the exterior of production tubing string 118 and an inside wall of wellbore 122.

Equipment, such as motors, valves, etc. may be coupled to a downhole end of production tubing string 118. The equipment may include an electronics-free (e.g., lacking on-board electronic components) flow sensor 138. A control line 140, such as a tubing encapsulated conductor (TEC) line can run from a drum 120 located at a surface 116, proximate to the production tubing string 118, and may be electrically coupled to the flow sensor 138. The control line 140 may also be electrically coupled to the receiver 106 at the surface 116. The control line 140 may transmit electrical signals or pulses between the flow sensor 138 and the receiver 106.

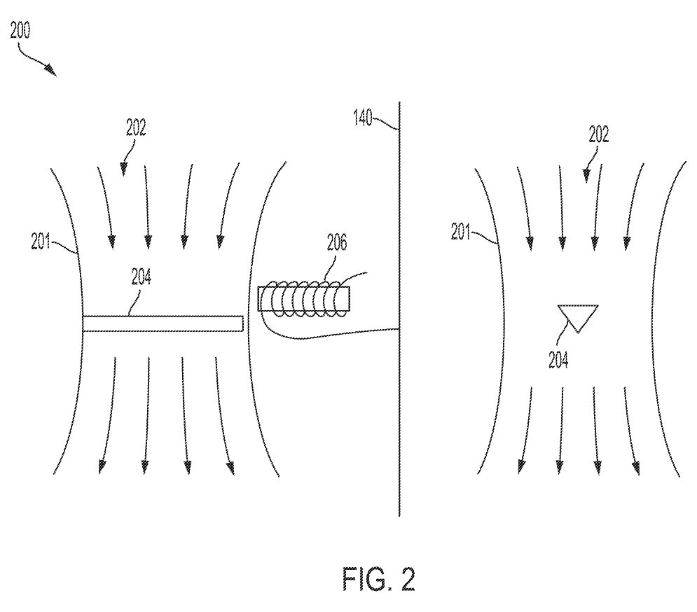

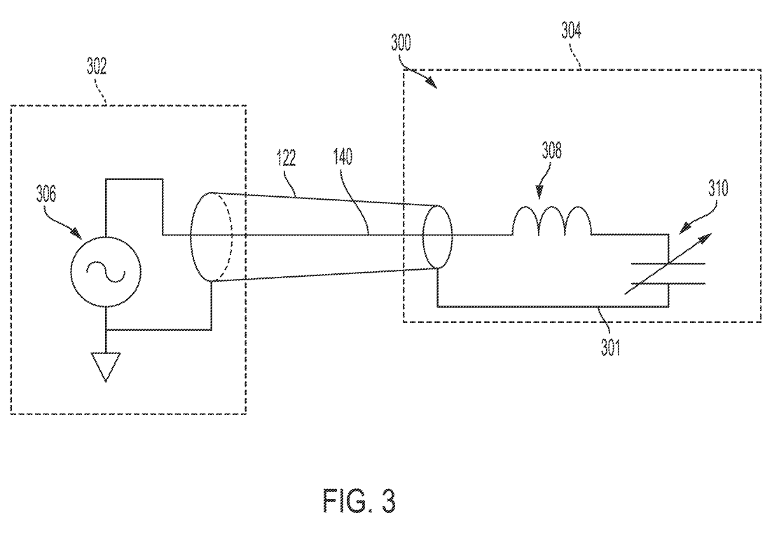

In some examples, the flow sensor 138 may be included within an inflow control device. For example, an inflow control device may include a channel conducting the flow of downhole fluids (e.g., production fluids, injected fluids, etc.) between the subterranean formation on the outside of the production tubing string 118 and the inside. These channels can provide an opportunity for measuring fluid flow, composition, or a combination thereof. For example, the flow sensor 138 may be placed within at least one channel of an inflow control device to sample passing fluid. The flow sensor 138 may include a flow velocity sensor, which is described in further detail below in relation to FIG. 2. Additionally or alternatively, the flow sensor 138 may include a flow composition sensor, which is described in further detail below in relation to FIG. 3. Both the flow velocity sensor and the flow composition sensor can be implemented in a same flow channel or even on a same control line 140. In other examples, the flow velocity sensor and the flow composition sensor may be implemented in different flow channels or with different control lines.

The flow sensor 138 can detect electrical signals indicative of flow velocity and flow composition. The electrical signals can be transmitted uphole to the receiver 106 via the control line 140. The receiver 106 can use the electrical signals to determine the resonant frequency of the flow sensor 138, which can then be used to determine flow velocity and/or flow composition. In some examples, to determine flow composition, electrical pulses can be transmitted downhole to the flow sensor 138 via the control line 140 (e.g., from the receiver 106). The electrical pulses transmitted from uphole can excite the flow sensor 138 to induce resonant frequency, which can be transmitted to the receiver 106 for use in determining flow composition of downhole fluid. Although the flow sensor 138 is described herein as transmitting electrical signals uphole to the receiver 106 at the surface 116, in other examples the receiver 106 may be located at a downhole location that is remote from the flow sensor 138. The receiver 106 may, for example, be positioned in a downhole node of an intelligent completion in the wellbore 122. Electrical cables may be run from the downhole node to the flow sensor 138 for transmission of electrical signals.

FIG. 2 is a diagram of a flow velocity sensor 200 of an electronics-free downhole flow sensor 138 according to one example of the present disclosure. The flow velocity sensor 200 can be positioned within a flow path 202 of a channel 201, such as a channel of an inflow control device. The flow velocity sensor 200 can include a wire 204 and a variable reluctance sensor 206. The variable reluctance sensor 206 may be coupled to the control line 140 of FIG. 1.

The wire 204 can be exposed to the flow path 202 of downhole fluid. When a non-streamlined object such as the wire 204 is placed in a fluid stream, a vortex can form in the fluid stream. The instability of the vortex may cause a phenomenon called vortex shedding to occur. The vortex shedding can cause forces on the wire 204, which may be a flexible wire. Thus, the wire 204 may oscillate or vibrate due to the vortex shedding of the fluid stream. To induce the vortex shedding, the wire 204 may have a triangular cross-section. A triangular cross-section may induce relatively powerful vortex shedding. In other examples, the cross-section of the wire 204 may include a rectangular or square cross-section, a half-circle cross-section, or any suitable cross-section to induce vortex shedding. By varying cross-section, length, and mass distribution of the wire 204, different base “tunings” can be made, much like the tone rods on a Fender Rhodes electric piano or the sound from an Aeolian Harp.

The wire 204 may be made of a ferromagnetic material such as iron, nickel, cobalt, steel, etc. In some examples, the entire wire 204 may be made of a ferromagnetic material. In other examples, only a section of the wire 204 may be made of a ferromagnetic material. Or, a ferromagnetic component may be affixed to the wire 204. The term “wire” can be understood herein as a mechanical component that has a length that is greater than a representative diameter, such as a length that is at least twice the dimension of the representative diameter. The wire 204 may be supported at one end, both ends, and/or along the length of the wire 204. Because the wire 204 is ferromagnetic, the frequency of the oscillation of the wire 204 can be detected by the variable reluctance sensor 206 (or any suitable magnetic pickup). For example, the oscillation of the wire 204 may change the magnetic field of the variable reluctance sensor 206, thus generating a voltage that is detected by the variable reluctance sensor 206. The variable reluctance sensor 206 may transmit the voltage as an electrical signal uphole (e.g., to the receiver 106 of FIG. 1) via the control line 140. In some examples, the variable reluctance sensor 206 may transmit the voltage as a direct current (DC) magnetic signal, such as from a permanent magnet or from an electromagnet. For example, the magnetic source of the DC magnetic signal can be built into the variable reluctance sensor 206 (e.g., as depicted in FIG. 2 by the core of the variable reluctance sensor 206 around which the wire 204 is wrapped) or may be proximate the variable reluctance sensor 206 such that movement of the wire 204 can result in changes in the magnetic field that passes through the variable reluctance sensor 206. The receiver 106 may determine the resonant frequency of the wire 204 based on the electrical signal or the DC magnetic signal and may therefore determine the fluid velocity of the downhole fluid based on the resonant frequency.

In some examples, the wire 204 may be encapsulated. The flow velocity sensor 200 may in some examples include multiple wires that can cover a wide range of vortex shedding frequencies. The flow velocity sensor 200 may, in some examples, not require external electrical excitation. Instead, the flow of the downhole fluid alone can cause the wire 204 to move. The moving wire 204 can produce a voltage due to the interaction with the magnetic field of the variable reluctance sensor 206. In some examples, an amplifier (e.g., separate from the flow velocity sensor 200) can be positioned proximate the flow velocity sensor 200 to amplify the electrical signal that is transmitted uphole to the receiver 106.

FIG. 3 is a cross-sectional diagram of a flow composition sensor 300 in the electronics-free downhole flow sensor 138 according to one example of the present disclosure. The flow composition sensor 300 can include a resonant circuit 301 with an uphole side 302 and a downhole side 304. The uphole side 302 can include an alternating current (AC) power source 306. The AC power source 306 can provide electrical pulses to the downhole side 304 via the control line 140 within the wellbore 122 (e.g., of FIG. 1). The control line 140 may be a same or different control line than the control line attached to the flow velocity sensor 200 of FIG. 2. The downhole side 304 can include an inductor 308 and a variable capacitor 310. In some examples, the variable capacitor 310 may be the only component in the resonant circuit 301 that is exposed to the flow of downhole fluid. In other examples, both the variable capacitor 310 and the inductor 308 may be exposed to the flow of downhole fluid. Additionally or alternatively, the variable capacitor 310 and/or the inductor 308 may be exposed to a sample of downhole fluid rather than being exposed to the flow of downhole fluid.

The resonant circuit 301 may be an LC resonant circuit. The resonant circuit 301 can act as an electrical resonator, storing energy oscillating at the resonant frequency of the resonant circuit 301. The capacitance of the variable capacitor 310 can be a function of a dielectric constant of a medium (e.g., downhole fluid) between the two conducting plates of the variable capacitor 310. As the composition of the downhole fluid changes, the dielectric constant changes, which in turn can change the capacitor value. The resonant frequency of the resonant circuit 301 can also change as the capacitor value changes. When excited with an electrical pulse (e.g., supplied by the AC power source 306 on the uphole side 302), the resonant frequency of the resonant circuit 301 can be measured (e.g., by the receiver 106 of FIG. 1). The measured resonant frequency can be used to estimate the composition of the downhole fluid passing through the conducting plates of the capacitor 310.

In some examples, the electrical pulse generated by the AC power source 306 may include a range of frequencies. Alternatively, sweeping single frequencies may be used for excitation. The resonant frequency can be measured as well as the damping rate. Although the resonant circuit 301 of FIG. 3 is depicted as being a series circuit, in other examples, the resonant circuit 301 may be a parallel circuit. A resonant circuit 301 in series may have a peak of relatively low impedance at resonant frequencies. A resonant circuit 301 in parallel may have a peak of relatively high impedance at resonant frequencies.

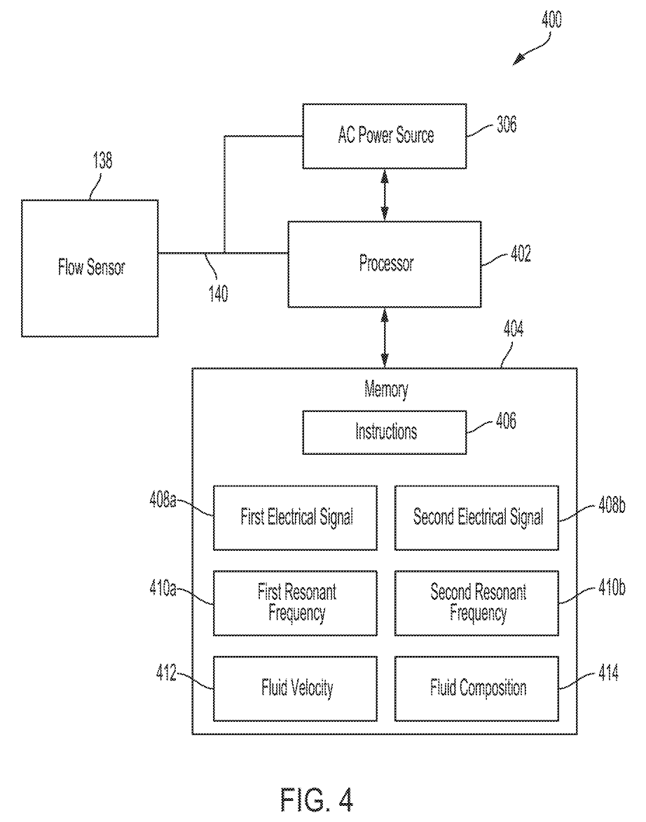

FIG. 4 is a block diagram of a receiver 106 for the electronics-free downhole flow sensor described herein according to one example of the present disclosure. The receiver 106 can include a processor 402 communicatively coupled to a memory 404. The processor 402 can be hardware that can include one processing device or multiple processing devices. Non-limiting examples of the processor 402 can include a Field-Programmable Gate Array (FPGA), an application-specific integrated circuit (ASIC), or a microprocessor. The processor 402 can execute instructions 406 stored in the memory 404 to perform computing operations. The instructions 406 may include processor-specific instructions generated by a compiler or an interpreter from code written in any suitable computer-programming language, such as C, C++, C#, Python, or Java.

The memory 404 can include one memory device or multiple memory devices. The memory 404 can be volatile or can be non-volatile, such that it can retain stored information when powered off. Some examples of the memory 404 can include electrically erasable and programmable read-only memory (EEPROM), flash memory, or any other type of non-volatile memory. At least some of the memory 404 can include a non-transitory computer-readable medium from which the processor 402 can read instructions 406. A computer-readable medium can include electronic, optical, magnetic, or other storage devices capable of providing the processor 402 with computer-readable instructions or other program code. Some examples of a computer-readable medium include magnetic disks, memory chips, ROM, random-access memory (RAM), an ASIC, a configured processor, optical storage, or any other medium from which a computer processor can read the instructions 406.

The processor 402 may additionally be communicatively coupled with an electronics-free flow sensor 138 via a control line 140. The processor 402 may also be coupled to an alternating current (AC) power source 306 that is additionally coupled to the control line 140. The processor 402 may receive electrical signals 408a-b from the flow sensor 138 (e.g., via the control line 140). The processor 402 may also transmit control signals to the AC power source 306. The control signals can cause the AC power source 306 to transmit electrical pulses to the flow sensor 138 (e.g., via the control line 140).

The electrical signals 408a-b received from the flow sensor 138 can be used to determine fluid velocity 412 and/or fluid composition 414 of downhole fluid contacting the flow sensor 138. For example, the flow sensor 138 may transmit a first electrical signal 408a from a flow velocity sensor (e.g., the flow velocity sensor 200 of FIG. 2). The processor 402 may exeute the instructions 406 to determine a first resonant frequency 410a of the flow velocity sensor based on the first electrical signal 408a. The resulting first resonant frequency 410a can then be used to identify a velocity of the downhole fluid that caused the first resonant frequency 410a of the flow velocity sensor.

In another example, the processor 402 may cause the AC power source 306 to generate an electrical pulse that is transmitted to a flow composition sensor (e.g., the flow composition sensor 300 of FIG. 3). The electrical pulse may induce a resonant frequency of the flow composition sensor, which may include a resonant circuit in contact with downhole fluid. The resonant circuit can store and transmit a second electrical signal 408b caused by the electrical pulse and the downhole fluid to the processor 402. The processor 402 can determine the second resonant frequency 410b of the resonant circuit based on the second electrical signal 408b. The resulting second resonant frequency 410b can then be used to identify a composition (e.g., a chemical composition) of the downhole fluid that caused the second resonant frequency 410b of the fluid composition sensor (e.g., in conjunction with the electrical pulse).

Although FIG. 4 shows a certain number and arrangement of components, this example is intended to be illustrative and non-limiting. Other examples may include more components, fewer components, different components, or a different arrangement of the components shown in FIG. 4. Any suitable arrangement of the depicted components is contemplated herein.

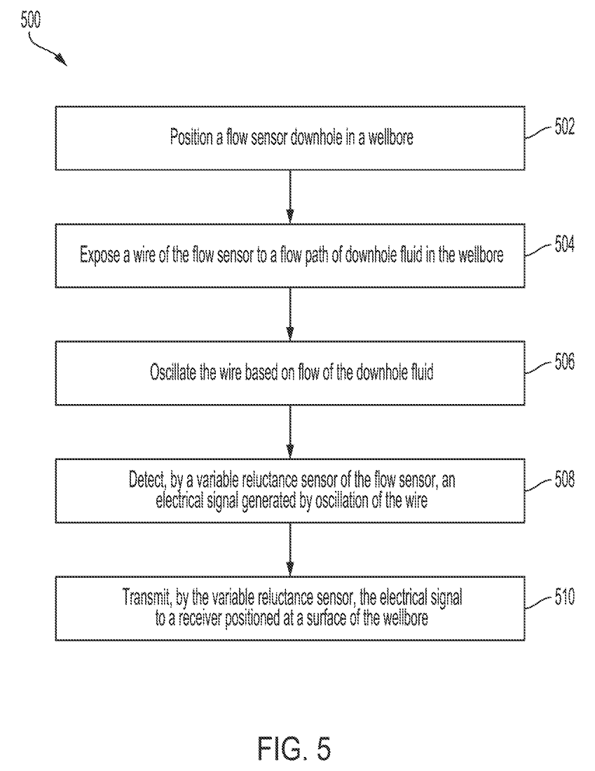

FIG. 5 is a flow chart of a process 500 for operating an electronics-free downhole flow sensor including a flow composition sensor according to one example of the present disclosure. While FIG. 5 depicts a certain sequence of steps for illustrative purposes, other examples can involve more steps, fewer steps, different steps, or a different order of the steps depicted in FIG. 5. The steps of FIG. 5 are described below with reference to the components of FIGS. 1-4 described above.

In block 502, a flow sensor 138 can be positioned downhole in a wellbore 122. The flow sensor 138 may not include any downhole electronics. The flow sensor 138 may include a flow velocity sensor 200 that, in some examples, may be positioned within a channel of an inflow control device. In some examples, the wellbore 122 may include multiple flow sensors that are placed in multiple regions of the wellbore 122. Or, multiple flow sensors may be placed within a single region of the wellbore. The flow velocity sensor 200 can include a wire 204 and a variable reluctance sensor 206. The wire 204 may be flexible and may be made of a ferromagnetic material. The variable reluctance sensor 206 may induce an electromagnetic field and may measure changes in magnetic reluctance.

In block 504, the wire 204 of the flow velocity sensor 200 can be exposed to a flow path 202 of downhole fluid in the wellbore 122. In some examples, the wire 204 may have a triangular cross-section (or any other suitable shape of cross-section) that can induce vortex shedding in the flow path 202 of downhole fluid. In block 506, the wire 204 can be oscillated based on flow of the downhole fluid. For example, the vortex shedding of the fluid may cause the wire 204 to oscillate at a particular resonant frequency. The oscillation of the wire 204 can cause variations in the electromagnetic field induced by the variable reluctance sensor 206.

In block 508, a variable reluctance sensor 206 of the flow sensor 138 can generate an electrical signal from the oscillation of the wire 204. For example, the electrical signal can be generated based on the variations in the electromagnetic field caused by the oscillation of the wire 204. Thus, the resulting electrical signal can indicate the resonant frequency of the wire oscillating in the downhole fluid. In block 510, the variable reluctance sensor 206 can transmit the electrical signal to a receiver 106 positioned at a surface of the wellbore 122. The receiver 106 can use the electrical signal to determine a first resonant frequency 410a of the wire 204. Different resonant frequencies may be associated with different velocities of fluid oscillating the wire 204. Thus, the receiver 106 can determine a fluid velocity 412 of the downhole fluid oscillating the wire 204 based on the first resonant frequency 410a.

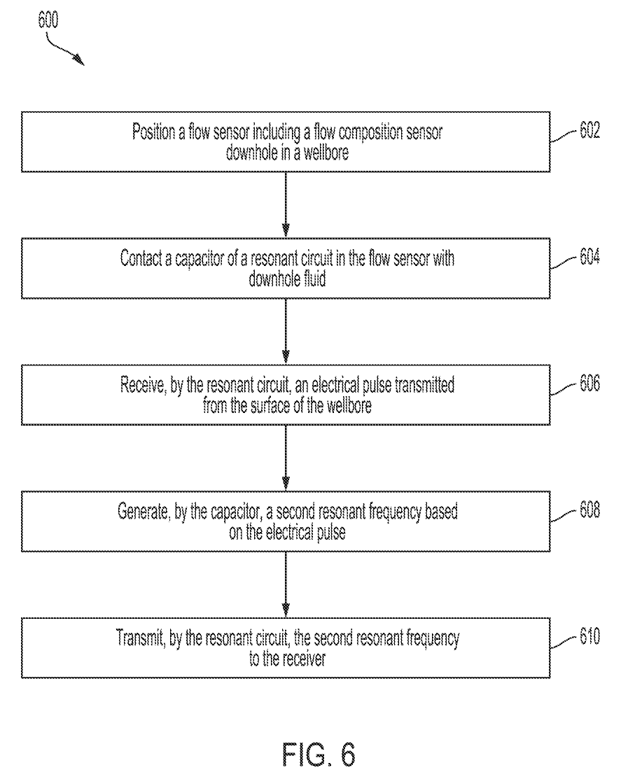

FIG. 6 is a flow chart of a process 600 for operating an electronics-free downhole flow sensor including a flow composition sensor according to one example of the present disclosure. While FIG. 6 depicts a certain sequence of steps for illustrative purposes, other examples can involve more steps, fewer steps, different steps, or a different order of the steps depicted in FIG. 6. The steps of FIG. 6 are described below with reference to the components of FIGS. 1-5 described above.

In block 602, a flow sensor 138 that includes a flow composition sensor 300 is positioned downhole in a wellbore 122. The flow sensor 138 may not include any downhole electronics. In some examples, the flow composition sensor 300 may, in some examples, be positioned in a channel of an inflow control device. In some examples, the wellbore 122 may include multiple flow sensors that are placed in multiple regions of the wellbore 122. Or, multiple flow sensors may be placed within a single region of the wellbore. The flow composition sensor 300 may include a resonant circuit 301 with an inductor 308 and a capacitor 310. The resonant circuit 301 may include an AC power source 306 at a surface of the wellbore 122. The resonant circuit 301 may be communicatively coupled to a receiver 106 at the surface of the wellbore 122 via a control line 140, such as a TEC line.

In block 604, a capacitor 310 of a resonant circuit 301 in the flow sensor 138 can be contacted with downhole fluid. The capacitor 310 may be a variable capacitor. The downhole fluid may contact conducting plates of the capacitor 310. In some examples, the capacitor 310 may be exposed to flow of downhole fluid. In other examples, the capacitor 310 may be exposed to a sample of downhole fluid. The capacitor 310 can measure a capacitance value. In block 606, the resonant circuit 301 can receive an electrical pulse transmitted from the surface of the wellbore 122. For example, the electrical pulse may be transmitted by the AC power source 306. The electrical pulse may affect capacitance of the capacitor 310.

In block 608, the capacitor 310 can generate a second resonant frequency 410b based on the electrical pulse. The second resonant frequency 410b may also be based on the composition of the downhole fluid that is contacting the capacitor 310. That is, different fluid compositions (e.g., gas, oil, water, etc.) may cause different resonant frequencies of the capacitor 310.

In block 610, the resonant circuit 301 can transmit the second resonant frequency 410b to the receiver 106. For example, a second electrical signal 408b detected by the capacitor 310 and representing the second resonant frequency 410b can be transmitted to the receiver 106 via the control line 140. The receiver 106 can use the second electrical signal 408b to determine a second resonant frequency 410b of the resonant circuit 301. Different resonant frequencies may be associated with different compositions of fluid contacting the capacitor 310. Thus, the receiver 106 can determine a fluid composition 414 of the downhole fluid contacting the capacitor 310 based on the second resonant frequency 410b. In examples where the flow sensor 138 includes both a flow velocity sensor 200 and a flow composition sensor 300, the receiver 106 may additionally determine a mass flow rate of the downhole fluid based on the fluid velocity 412 and the fluid composition 414.

In some aspects, system, method, and apparatus for an electronics-free downhole flow sensor are provided according to one or more of the following examples:

As used below, any reference to a series of examples is to be understood as a reference to each of those examples disjunctively (e.g., "Examples 1-4" is to be understood as "Examples 1, 2, 3, or 4").

Example 1 is a system comprising: a receiver positionable at a surface of a wellbore; and a flow sensor positionable downhole in the wellbore, wherein the flow sensor comprises: a wire positionable within a flow path of downhole fluid in the wellbore, the wire being configurable to oscillate based on flow of the downhole fluid; and a variable reluctance sensor configurable to detect an electrical signal generated by oscillation of the wire and to transmit the electrical signal to the receiver.

Example 2 is the system of example(s) 1, wherein the receiver is configurable to: receive the electrical signal from the variable reluctance sensor; determine, based on the electrical signal, a first resonant frequency of the wire; and determine, based on the first resonant frequency, a fluid velocity of the downhole fluid.

Example 3 is the system of example(s) 1-2, wherein the electrical signal is a first electrical signal, and wherein the flow sensor further comprises: a resonant circuit comprising: a capacitor positionable to contact the downhole fluid and configurable to generate a second resonant frequency based on an electrical pulse transmitted from the surface of the wellbore, wherein the resonant circuit is configurable to transmit the second resonant frequency to the receiver.

Example 4 is the system of example(s) 1-3, wherein the receiver is further configurable to: receive the second resonant frequency from the resonant circuit; and determine, based on the second resonant frequency, a composition of the downhole fluid.

Example 5 is the system of example(s) 1-4, wherein the wire comprises a ferromagnetic material.

Example 6 is the system of example(s) 1-5, wherein the wire comprises a triangular cross-sectional shape.

Example 7 is the system of example(s) 1-6, wherein the flow sensor does not include downhole electronics.

Example 8 is a method comprising: positioning a flow sensor downhole in a wellbore; exposing a wire of the flow sensor to a flow path of downhole fluid in the wellbore; oscillating the wire based on flow of the downhole fluid; detecting, by a variable reluctance sensor of the flow sensor, an electrical signal generated by oscillation of the wire; and transmitting, by the variable reluctance sensor, the electrical signal to a receiver positioned at a surface of the wellbore.

Example 9 is the method of example(s) 8, wherein the receiver is configured to: receive the electrical signal from the variable reluctance sensor; determine, based on the electrical signal, a first resonant frequency of the wire; and determine, based on the first resonant frequency, a fluid velocity of the downhole fluid.

Example 10 is the method of example(s) 8-9, wherein the electrical signal is a first electrical signal, and wherein the method further comprises: contacting a capacitor of a resonant circuit in the flow sensor with downhole fluid; receiving, by the resonant circuit, an electrical pulse transmitted from the surface of the wellbore; generating, by the capacitor, a second resonant frequency based on the electrical pulse; and transmitting, by the resonant circuit, the second resonant frequency to the receiver.

Example 11 is the method of example(s) 8-10, wherein the receiver is further configured to: receive the second resonant frequency from the resonant circuit; and determine, based on the second resonant frequency, a composition of the downhole fluid.

Example 12 is the method of example(s) 8-11, wherein the wire comprises a ferromagnetic material.

Example 13 is the method of example(s) 8-12, wherein the wire comprises a triangular cross-sectional shape.

Example 14 is the method of example(s) 8-13, wherein the flow sensor does not include downhole electronics.

Example 15 is a flow sensor comprising: a wire positionable within a flow path of downhole fluid in a wellbore, the wire being configurable to oscillate based on flow of the downhole fluid; and a variable reluctance sensor configurable to detect an electrical signal generated by oscillation of the wire and to transmit the electrical signal to a receiver positionable at a surface of the wellbore.

Example 16 is the flow sensor of example(s) 15, wherein the receiver is configurable to: receive the electrical signal from the variable reluctance sensor; determine, based on the electrical signal, a first resonant frequency of the wire; and determine, based on the first resonant frequency, a fluid velocity of the downhole fluid.

Example 17 is the flow sensor of example(s) 15-16, wherein the electrical signal is a first electrical signal, and wherein the flow sensor further comprises: a resonant circuit comprising: a capacitor positionable to contact the downhole fluid and configurable to generate a second resonant frequency based on an electrical pulse transmitted from the surface of the wellbore, wherein the resonant circuit is configurable to transmit the second resonant frequency to the receiver.

Example 18 is the flow sensor of example(s) 15-17, wherein the receiver is further configurable to: receive the second resonant frequency from the resonant circuit; and determine, based on the second resonant frequency, a composition of the downhole fluid.

Example 19 is the flow sensor of example(s) 15-18, wherein the wire comprises a ferromagnetic material.

Example 20 is the flow sensor of example(s) 15-19, wherein the flow sensor does not include downhole electronics.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a receiver positionable at a surface of a wellbore; and
a flow sensor positionable downhole in the wellbore, wherein the flow sensor comprises:
a wire positionable within a flow path of downhole fluid in the wellbore, the wire being configurable to oscillate based on flow of the downhole fluid; and
a variable reluctance sensor configurable to detect an electrical signal generated by oscillation of the wire and to transmit the electrical signal to the receiver.

2. The system of claim 1, wherein the receiver is configurable to:
receive the electrical signal from the variable reluctance sensor;
determine, based on the electrical signal, a first resonant frequency of the wire; and
determine, based on the first resonant frequency, a fluid velocity of the downhole fluid.

3. The system of claim 1, wherein the electrical signal is a first electrical signal, and wherein the flow sensor further comprises:
a resonant circuit comprising:
a capacitor positionable to contact the downhole fluid and configurable to generate a second resonant frequency based on an electrical pulse transmitted from the surface of the wellbore, wherein the resonant circuit is configurable to transmit the second resonant frequency to the receiver.

4. The system of claim 3, wherein the receiver is further configurable to:
receive the second resonant frequency from the resonant circuit; and
determine, based on the second resonant frequency, a composition of the downhole fluid.

5. The system of claim 1, wherein the wire comprises a ferromagnetic material.

6. The system of claim 1, wherein the wire comprises a triangular cross-sectional shape.

7. The system of claim 1, wherein the flow sensor does not include downhole electronics.

8. A method comprising:
positioning a flow sensor downhole in a wellbore;
exposing a wire of the flow sensor to a flow path of downhole fluid in the wellbore;
oscillating the wire based on flow of the downhole fluid;
detecting, by a variable reluctance sensor of the flow sensor, an electrical signal generated by oscillation of the wire; and
transmitting, by the variable reluctance sensor, the electrical signal to a receiver positioned at a surface of the wellbore.

9. The method of claim 8, wherein the receiver is configured to:
receive the electrical signal from the variable reluctance sensor;
determine, based on the electrical signal, a first resonant frequency of the wire; and
determine, based on the first resonant frequency, a fluid velocity of the downhole fluid.

10. The method of claim 8, wherein the electrical signal is a first electrical signal, and wherein the method further comprises:
contacting a capacitor of a resonant circuit in the flow sensor with downhole fluid;
receiving, by the resonant circuit, an electrical pulse transmitted from the surface of the wellbore;
generating, by the capacitor, a second resonant frequency based on the electrical pulse; and
transmitting, by the resonant circuit, the second resonant frequency to the receiver.

11. The method of claim 10, wherein the receiver is further configured to:
receive the second resonant frequency from the resonant circuit; and
determine, based on the second resonant frequency, a composition of the downhole fluid.

12. The method of claim 8, wherein the wire comprises a ferromagnetic material.

13. The method of claim 8, wherein the wire comprises a triangular cross-sectional shape.

14. The method of claim 8, wherein the flow sensor does not include downhole electronics.

15. A flow sensor comprising:
a wire positionable within a flow path of downhole fluid in a wellbore, the wire being configurable to oscillate based on flow of the downhole fluid; and
a variable reluctance sensor configurable to detect an electrical signal generated by oscillation of the wire and to transmit the electrical signal to a receiver positionable at a surface of the wellbore.

16. The flow sensor of claim 15, wherein the receiver is configurable to:
receive the electrical signal from the variable reluctance sensor;
determine, based on the electrical signal, a first resonant frequency of the wire; and
determine, based on the first resonant frequency, a fluid velocity of the downhole fluid.

17. The flow sensor of claim 15, wherein the electrical signal is a first electrical signal, and wherein the flow sensor further comprises:
a resonant circuit comprising:
a capacitor positionable to contact the downhole fluid and configurable to generate a second resonant frequency based on an electrical pulse transmitted from the surface of the wellbore, wherein the resonant circuit is configurable to transmit the second resonant frequency to the receiver.

18. The flow sensor of claim 17, wherein the receiver is further configurable to:
receive the second resonant frequency from the resonant circuit; and
determine, based on the second resonant frequency, a composition of the downhole fluid.

19. The flow sensor of claim 15, wherein the wire comprises a ferromagnetic material.

20. The flow sensor of claim 15, wherein the flow sensor does not include downhole electronics.
